(19) United States
(12) Patent Application Publication
(10) Pub. No.: US 2026/0008331 A1
(43) Pub. Date: Jan. 8, 2026

(54) OMNIDIRECTIONAL ROTATION DRIVE APPARATUS

(71) Applicants: HYUNDAI MOTOR COMPANY, Seoul (KR); KIA CORPORATION, Seoul (KR)

(72) Inventors: Jun Ho Seong, Hwaseong-si (KR); Sang Woo Hwang, Hwaseong-si (KR)

(73) Assignees: HYUNDAI MOTOR COMPANY, Seoul (KR); KIA CORPORATION, Seoul (KR)

(21) Appl. No.: 18/948,714

(22) Filed: Nov. 15, 2024

(30) Foreign Application Priority Data
Jul. 3, 2024 (KR) 10-2024-0087216

(51) Int. Cl. B60K 7/00; B60K 17/04

(52) U.S. Cl. CPC B60K 7/0007; B60K 17/043; B60K 2007/0061

(57) ABSTRACT

An omnidirectional rotation drive apparatus includes a knuckle connected to a vehicle body, a wheel body unit rotatably fixed to the knuckle, a sub-wheel drive shaft rotatably supported on the wheel body unit, sub-wheel units rotatably supported on the wheel body unit, and transmission units connected to the sub-wheel drive shaft to transmit rotational force from the sub-wheel drive shaft to the sub-wheel units. The sub-wheel units are rotated depending on an angular velocity difference between the wheel body unit and the sub-wheel drive shaft.

### CROSS-REFERENCE TO RELATED APPLICATION

This application claims under 35 U.S.C. § 119 (a) the benefit of priority to Korean Patent Application No. 10-2024-0087216 filed on Jul. 3, 2024, the entire contents of which are incorporated herein by reference.

### BACKGROUND

### (a) Technical Field

The present disclosure relates to an omnidirectional rotation drive apparatus. More particularly, the present disclosure relates to an omnidirectional rotation drive apparatus including a plurality of sub-wheels arranged in two rows on the outer surface of a wheel body.

### (b) Background Art

Recently, in the case of electric vehicles, development of an omnidirectional wheel structure that allows straight driving without change in a steering angle is being carried out. The omnidirectional wheel is also called an omni wheel, which means a wheel that can move in all directions. The omni wheel enables special movements, such as rotation in place, horizontal movement to the left, and horizontal movement to the right of a transportation device. Such movements may not be achieved with general wheels, due to the structure of the omni wheel.

However, conventionally developed omni wheel structures have a discontinuous sub-wheel structure and low power transmission efficiency and may not be applied to vehicles using the existing suspension structure of the vehicles.

The above information disclosed in this Background section is only to enhance understanding of the background of the disclosure. Therefore, the Background section may contain information that does not form the prior art that is already known to a person of ordinary skill in the art.

### SUMMARY

The present disclosure has been made in an effort to solve the above-described problems associated with the prior art. It is an object of the present disclosure to provide an omnidirectional rotation drive apparatus that allows a vehicle to move in a first direction through a wheel body and allows the vehicle to move in a second direction by selectively driving sub-wheels.

It is another object of the present disclosure to provide an omnidirectional rotation drive apparatus that includes transmission units located inside a wheel body coupled to a first motor and coupled to a second motor and may thus selectively drive sub-wheels.

The objects of the present disclosure are not limited to the above-mentioned objects. Other objects not mentioned herein should be more clearly understood by those of ordinary skill in the art from the following description and should be more clearly understood from embodiments of the present disclosure. Further, the objects of the present disclosure may be realized by the apparatuses and combinations thereof disclosed in the claims.

An omnidirectional rotation drive device for achieving the above-described objects of the present disclosure includes the following configurations.

In one aspect, the present disclosure provides an omnidirectional rotation drive apparatus including a knuckle connected to a vehicle body, a wheel body unit rotatably fixed to the knuckle, a sub-wheel drive shaft rotatably supported on the wheel body unit, sub-wheel units rotatably supported on the wheel body unit, and transmission units connected to the sub-wheel drive shaft to transmit rotational force from the sub-wheel drive shaft to the sub-wheel units. The sub-wheel units are rotated depending on an angular velocity difference between the wheel body unit and the sub-wheel drive shaft.

In an embodiment, the wheel body unit may include a main wheel drive shaft rotatably supported on the knuckle and a wheel body coupled to the main wheel drive shaft. The wheel body unit may have a space formed therein so that a portion of each of the transmission units is located in the space.

In another embodiment, at least a portion of each of the transmission units may be located between the main wheel drive shaft and the wheel body.

In still another embodiment, each of the sub-wheel units may include a plurality of sub-wheels and central axes of rotation of the plurality of sub-wheels may be perpendicular to a central axis of rotation of the wheel body.

In yet another embodiment, the sub-wheel units may be arranged to form two rows with the wheel body unit interposed therebetween in a direction of an axis of rotation of the wheel body.

In still yet another embodiment, the omnidirectional rotation drive apparatus may further include a first motor configured to rotate the main wheel drive shaft and a second motor configured to rotate the sub-wheel drive shaft.

In a further embodiment, each of the transmission units may include a first gear connected to the sub-wheel drive shaft, a second gear engaged with the first gear, a third gear arranged coaxially with the second gear, a fourth gear engaged with the third gear and connected to a corresponding one of the sub-wheel units, and a transmission unit housing.

In another further embodiment, the third gear and the fourth gear may be arranged so that an axis of rotation of the third gear and an axis of rotation of the fourth gear are perpendicular to each other.

In still another further embodiment, the transmission unit housing may be fixed to the wheel body and the second gear may be rotatably supported on the wheel body unit.

In yet another further embodiment, the omnidirectional rotation drive apparatus may further include support rollers fixed to the wheel body to rotatably support the plurality of sub-wheels.

In still yet another further embodiment, if the wheel body unit and the sub-wheel drive shaft are rotated at the same angular velocity, only the wheel body may be rotated.

In a still further embodiment, if the wheel body unit and the sub-wheel drive shaft are rotated at different angular velocities or if the wheel body unit is rotated and the sub-wheel drive shaft is stopped, the wheel body and the sub-wheel units may be rotated simultaneously.

In a yet still further embodiment, if the wheel body unit is stopped and the sub-wheel drive shaft is rotated, only the sub-wheel units may be rotated.

Other aspects and embodiments of the disclosure are discussed herein.

The above and other features of the disclosure are discussed herein.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is a perspective view of an omnidirectional rotation drive apparatus according to one embodiment of the present disclosure;

FIG. 2 is a rear perspective view of the omnidirectional rotation drive apparatus according to one embodiment of the present disclosure;

FIG. 3 is a front view of the omnidirectional rotation drive apparatus according to one embodiment of the present disclosure;

FIG. 4 is a cross-sectional view of the omnidirectional rotation drive apparatus of FIG. 3 according to one embodiment of the present disclosure;

FIG. 5 is a view showing a coupling relationship among a knuckle, a first motor, and a second motor according to one embodiment of the present disclosure;

FIGS. 6A and 6B are views showing a coupling structure of a transmission unit according to one embodiment of the present disclosure;

FIG. 7 is a side view showing a positional relationship of support rollers according to one embodiment of the present disclosure;

FIG. 8 is a view showing a configuration of sub-wheel units continuously formed on the outer circumferential surface of a wheel body according to one embodiment of the present disclosure; and

FIGS. 9A-9C are views showing a driving relationship between a main wheel and sub-wheels according to one embodiment of the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, the same reference numbers refer to the same or equivalent parts of the present disclosure throughout the several figures of the drawings.

### DETAILED DESCRIPTION

Hereinafter, reference is made in detail to various embodiments of the present disclosure, examples of which are illustrated in the accompanying drawings and described below. The present disclosure is not limited to the following embodiments and the embodiments may be implemented in various different forms. The embodiments are provided to make the description of the present disclosure thorough and to more fully convey the scope of the present disclosure to those of ordinary skill in the art.

Further, in the following description of the embodiments, it should be understood that the suffixes “ . . . part”, “ . . . unit”, “ . . . module”, etc. indicate units for processing at least one function or operation, and may be implemented as software, hardware, or a combination of software and hardware.

Further, the terminology used herein is for the purpose of describing particular embodiments only and is not intended to be limiting. As used herein, singular expressions may be intended to include plural expressions as well, unless the context clearly indicates otherwise.

In addition, in the following description of the present disclosure, although the terms first, second, etc. may be used herein to describe various elements, these terms may be only used to distinguish one element from other elements, and do not imply a sequence or order unless clearly indicated by the context.

In the following description of the present disclosure, a first direction refers to the forward and backward directions of a vehicle. Moreover, the width direction of the vehicle, which is perpendicular to the first direction, is hereinafter referred to as a second direction.

When a component, device, element, or the like of the present disclosure is described as having a purpose or performing an operation, function, or the like, the component, device, element, or the like should be considered herein as being “configured to” meet that purpose or to perform that operation or function. Each component, device, element, or the like may separately embody or be included with a processor and a memory, such as a non-transitory computer readable media, as part of the apparatus.

Hereinafter, various embodiments are described in detail with reference to the accompanying drawings. In the description with reference to the accompanying drawings, the same or corresponding components are indicated by the same reference numerals and a redundant description thereof has thus been omitted.

The present disclosure relates to an omnidirectional rotation drive apparatus, and more particularly, to a drive apparatus having an omni-structure. The apparatus includes a wheel body unit 20 rotated in a first direction and a plurality of sub-wheels 110 located on the outer circumferential surface of the wheel body unit 20 and rotated in a second direction. Thus, the apparatus may move in all directions. Here, a sub-wheel unit 100 is a concept that includes a plurality of sub-wheels 110 located in the one row.

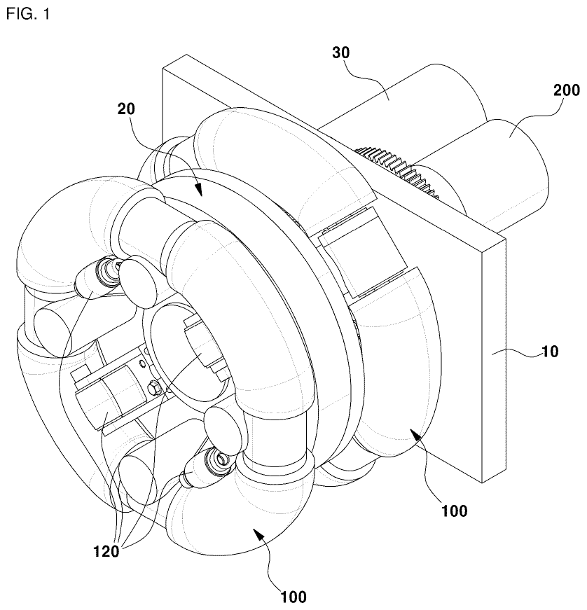

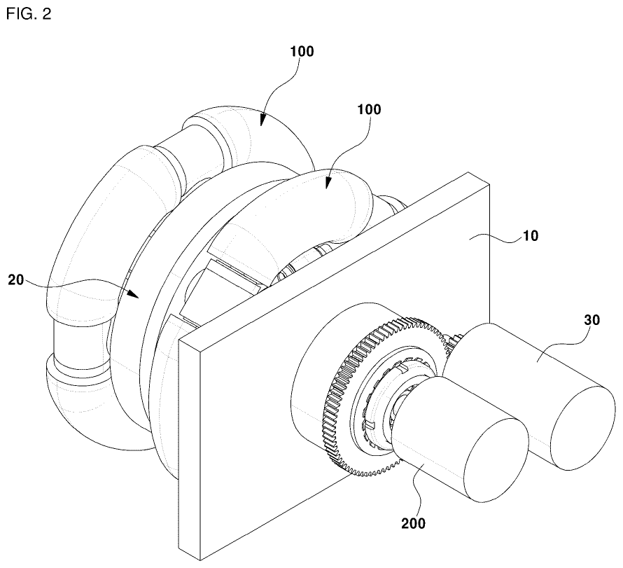

As shown in FIGS. 1 and 2, the omnidirectional rotation drive apparatus of the present disclosure includes a knuckle 10, which is at least partially located on a vehicle, and a first motor 30, which is located on the knuckle 10 to rotate the wheel body unit 20 about the knuckle 10. More specifically, the wheel body unit 20 may be located at one end of the knuckle 10 and a first motor 30 is configured such that a stator is located on the knuckle 10 and a rotor is rotated integrally with the wheel body unit 20. Otherwise, a main wheel drive shaft 22 coupled to a wheel body 21 may be coupled to the first motor 30 on the inner surface of the knuckle 10 to transmit driving force to the wheel body unit 20 through the main wheel drive shaft 22.

The main wheel drive shaft 22 may be configured to be coupled to the wheel body 21 and an inner space may be located between the main wheel drive shaft 22 and the wheel body 21. The inner space includes transmission unit housings 350 in areas adjacent to the sub-wheels 110. At least a portion of each of transmission units 300 is located in the transmission unit housing 350 to apply driving force applied from a second motor 200 to the plurality of sub-wheels 110.

Furthermore, the wheel body unit 20 includes the main wheel drive shaft 22, which penetrates the knuckle 10 and is coupled to the first motor 30, and the wheel body 21 coupled to the main wheel drive shaft 22. In addition, the transmission units 300 are located in the inner space where the wheel body 21 and the main wheel drive shaft 22 face each other. The wheel body 21 and the main wheel drive shaft 22 are configured to be fixed to each other and are rotated about the knuckle 10 if or when driving force is applied from the first motor 30.

In addition, the first motor 30 is configured such that the stator of the first motor 30 is fixed to the vehicle body. If or when current is applied to rotate the main wheel drive shaft 40 including the rotor of the first motor 30, the rotor and the wheel body unit 20 are rotated integrally. Further, the wheel body unit 20 is configured to be rotated in the first direction and the driving force of the vehicle in the forward and backward directions is applied to the wheel body unit 20 through the first motor 30.

The wheel body unit 20 may be positioned through the knuckle 10 and may be coupled to the first motor 30 fixed to the vehicle body. The plurality of sub-wheels 110 extend from inner and outer areas of the wheel body unit 20 adjacent to the outer circumferential surface of the wheel body unit 20 in the radial direction. The plurality of sub-wheels 110 is coupled to the wheel body unit 20. The sub-wheels 110 of the present disclosure is configured to be rotated in a direction perpendicular to the central axis of rotation of the wheel body unit 20 by rotational force of a sub-wheel drive shaft 210 located inside the wheel body unit 20.

Further, the second motor 200 located on the vehicle body is coupled to the sub-wheel drive shaft 210 penetrating the main wheel drive shaft 22. Driving force of the second motor 200 is transmitted to the sub-wheels 110 through the transmission units 300 located between the sub-wheel drive shaft 210 and the sub-wheels 110.

In the illustrated embodiment, one first gear 310 coupled to the sub-wheel drive shaft 210 is located in the radial direction of the wheel body unit 20. Further, driving force applied from the first gear 310 is applied to each of the plurality of sub-wheels 110 forming the sub-wheel units 100 arranged in two rows along the inner and outer areas of the wheel body unit 20.

In one embodiment of the present disclosure, the sub-wheel drive shaft 210 includes the plurality of sub-wheels 110 coupled thereto through the first gear 310. In addition, the plurality of sub-wheels 110 forms two adjacent rows. As shown in these figures, the sub-wheel units 100, each of which includes the plurality of sub-wheels 110, are arranged in the two rows on both side surfaces of the wheel body unit 20.

The sub-wheel units 100 arranged in the two rows according to the present disclosure may include a first sub-wheel unit 100a formed along the outer circumferential surface of the wheel body 21 and a second wub-wheel unit 100b located adjacent to the outer circumferential surface of the main wheel drive shaft 22. The first sub-wheel unit 100a is located relatively far away from the knuckle 10 in the second direction compared to the second sub-wheel unit 100b. Each of the first sub-wheel unit 100a and the second sub-wheel unit 100b may include the plurality of sub-wheels 110.

Moreover, each of the sub-wheel units 100 arranged in two rows is configured to surround an area adjacent to the outer circumferential surface of the wheel body unit 20 through the plurality of sub-wheels 110. More specifically, the sub-wheel unit 100 in one row may be configured such that the sub-wheels 110 thereof are spaced apart from each other at an angle of 90 degrees with respect to the central axis of the wheel body unit 20. As such, the sub-wheel units 100 may be arranged in two rows, and the sub-wheels 110 located in the same row may be coupled to the respective transmission units 300 to be spaced apart from each other at the angle of 90 degrees. Further, the sub-wheel units 100 arranged in the two rows are configured such that the sub-wheels 110 located in one row are arranged at an angle of about 45 degrees with the sub-wheels 110 located in the other row with respect to the central axis of the wheel body unit 2.

In other words, the omnidirectional rotation drive apparatus of the present disclosure includes the sub-wheel units 100 arranged in at least two rows. The sub-wheel units 100 are located in the outer and inner areas of the outer circumferential surface of the wheel body unit 20, respectively. Further, the transmission units 300) may be configured such that the sub-wheels 110 are rotated in a direction perpendicular to the outer circumferential surface of the wheel body unit 20. Also, the sub-wheel units 100 may be arranged in two or more rows.

In addition, the sub-wheel units 110 arranged in two rows adjacent to the outer circumferential surface of the wheel body unit 20 are located in inner and outer areas in the second direction along the outer circumferential surface of the wheel body unit 20 to be spaced apart from each other by the same distance. The sub-wheels 110 of the sub-wheel unit 110 in one row alternate with the sub-wheels 110 of the sub-wheel unit 110 in the other row. Therefore, when viewed from the side of the wheel body unit 20, the sub-wheels 110 arranged in the two rows have the shape of a continuous circle.

As shown in FIG. 2, a rotating shaft of the first motor 30 may be coupled to the outer circumferential surface of the main wheel drive shaft 22 to rotate the wheel body unit 20. Moreover, the rotating shaft of the first motor 30 may include any structure having a coupling relationship with the main wheel drive shaft 22 that is capable of transmitting power thereto. For example, the rotating shaft of the first motor 30 and the main wheel drive shaft 22 may include at least one power transmission structure selected from a gear engagement structure, a worm gear engagement structure, a bevel gear engagement structure, chains, or belts.

A rotor of the second motor 200 is coupled to the sub-wheel drive shaft 210. The sub-wheel drive shaft 210 is located through the center of the main wheel drive shaft 22 and is configured to be rotatable independently of the main wheel drive shaft 22.

Further, the main wheel drive shaft 22 located through the knuckle 10 is configured to be rotatable independently of the knuckle 10 through a bearing located on the inner circumferential surface of the knuckle 10.

Accordingly, the knuckle 10, the main wheel drive shaft 22, and the sub-wheel drive shaft 210 may include various types of bearings on contact surfaces therebetween so as to be rotatable independently of each other.

As disclosed above, the omnidirectional rotation drive apparatus may include the sub-wheel units 100 in two rows coupled to the wheel body unit 20 in the second direction along the outer circumferential surface thereof. The plurality of sub-wheels 110 may be alternately located in the row of each sub-wheel unit 100 in the second direction adjacent to the outer circumferential surface of the wheel body unit 20.

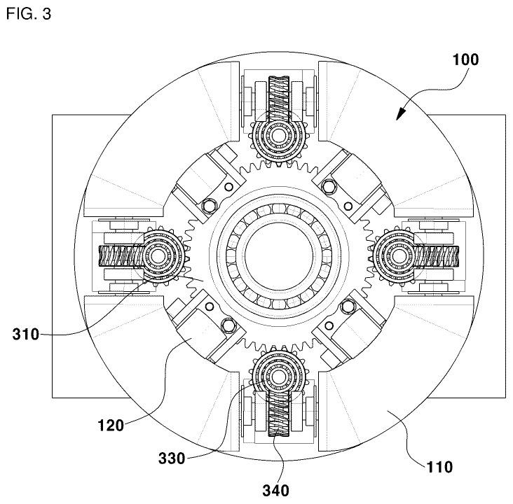

FIG. 3 is a front view of the omnidirectional rotation drive apparatus according to one embodiment of the present disclosure.

The wheel body unit 20 is coupled around the knuckle 10 and at least one sub-wheel 110 is located adjacent to the outer circumferential surface of the wheel body unit 20. The sub-wheels 110 are coupled to the transmission units 300 located inside the wheel body unit 20 and are configured to transmit the rotational force of the sub-wheel drive shaft 210 to each sub-wheel 110.

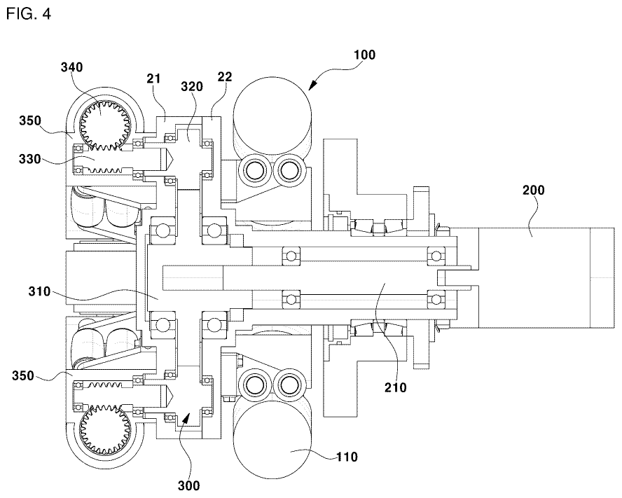

Moreover, as shown in FIGS. 3 and 4, in one embodiment of the present disclosure, the sub-wheel unit 100 forming one row includes four sub-wheels 110 coupled to four transmission units 300, respectively. The four transmission units 300 are located to be spaced apart from each other at intervals of an angle of 90 degrees with respect to the central axis of the wheel body unit 20. Further, the sub-wheels 110 are alternately located in two rows in the second direction. In addition, the omnidirectional rotation drive apparatus may include support rollers 120 located between the sub-wheel units 100 in one row spaced apart from each other to support the rear surfaces of the sub-wheels 110 in the other row and which are located alternately with the sub-wheel units 100 in the one row.

The support rollers 120 have one end coupled to the wheel body unit 20 and are configured to support the rear surfaces of the plurality of sub-wheels 110 forming the sub-wheel units 100 located on both sides of the wheel body unit 20.

Therefore, the support rollers 120 may be configured such that one end of each of the support rollers 120 comes into contact with the rear surface of a corresponding one of the plurality of sub-wheels 110 located in each row. The other end of each of the support rollers 120 is coupled to the wheel body unit 20 so as to support the rear surfaces of the sub-wheels 110.

FIG. 4 is a cross-sectional view of the omnidirectional rotation drive apparatus according to one embodiment of the present disclosure.

As shown in FIG. 4, the omnidirectional rotation drive apparatus includes the knuckle 10 fixed to the vehicle body, the main wheel drive shaft 220 located through the knuckle 10, and the sub-wheel drive shaft 210 located through the center of the main wheel drive shaft 22.

The main wheel drive shaft 22 is coupled to the first motor 30 on the inner surface of the knuckle 10 in the second direction and the sub-wheel drive shaft 210 is coupled to the second motor 200. The first motor 30 and the second motor 200 may be located adjacent to each other on the inner surface of the knuckle 10, the central shaft of the second motor 200 may be directly coupled to the sub-wheel drive shaft 210, and the central shaft of the first motor 30 may be gear-engaged with the main wheel drive shaft 22 to apply driving force thereto.

The sub-wheel drive shaft 210 coupled to the second motor 200 is coupled to the transmission units 300 located inside the wheel body unit 20. Moreover, the sub-wheel drive shaft 210 is coupled to the first gear 310 of the transmission units 300 and transmits the driving force of the second motor 200 to the sub-wheels 110 through second to fourth gears 320, 330, and 340 of the transmission units 300. More specifically, the third and fourth gears 330 and 340 may be located inside the wheel body unit 20 to be gear-engaged with each other in the transmission unit housing 350 so as to transmit the driving force to each sub-wheel 110.

More specifically, the sub-wheel units 100 formed in two rows are located at both ends of the wheel body unit 20 with respect to one first gear 310. The third gears 330 protrude from both side surfaces of the wheel body unit 20 so that the fourth gears 340 are coupled to the sub-wheels 110, respectively.

Therefore, if the sub-wheel drive shaft 210 is rotated by the rotational force of the second motor 200, the first gear 310 coupled to the sub-wheel drive shaft 210 applies the rotational force to the sub-wheels 110, and the sub-wheels 110 are rotated in the second direction using the outer circumferential direction of the wheel body unit 20 as a central axis. More specifically, both ends of one sub-wheel 110 are coupled to respective transmission units 300 so that driving force may be applied to the sub-wheel 110.

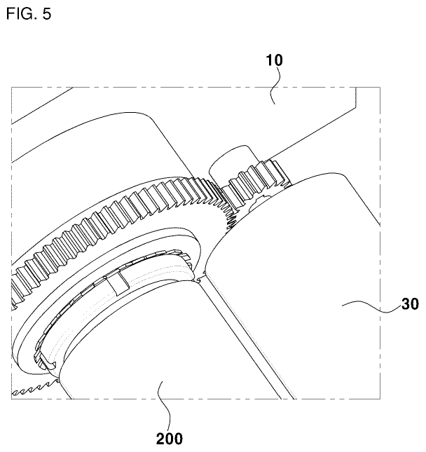

FIG. 5 is a view showing a coupling relationship between the first motor 30 and the second motor 200 located on the inner surface of the knuckle 10 according to one embodiment of the present disclosure.

The first motor 30 is located on the inner surface of the knuckle 10 to be spaced apart from the central axis of rotation of the second motor 200 and is located adjacent to the outer circumferential surface of the main wheel drive shaft 220 protruding from the inner surface of the knuckle 10. In one embodiment of the present disclosure, the main wheel drive shaft 22 has gear teeth formed along the outer circumferential surface of one end thereof protruding from the inner surface of the knuckle 10. The first motor 30 has gear teeth formed on the central shaft thereof so that the main wheel drive shaft 22 and the first motor 30 may be coupled to each other. More specifically, the central shaft of the first motor 30 and the main wheel drive shaft 22 may be gear-engaged with each other.

The second motor 200 is located adjacent to the first motor 30 and the rotating shaft of the second motor 200 coincides with the central axis of the drive shaft 210.

The sub-wheel drive shaft 210 penetrates the inner surface of the main wheel drive shaft 22 and is coupled to the wheel body unit 20. Thus, the sub-wheel drive shaft 210 may be rotated independently of the main wheel drive shaft 22.

More specifically, a ball bearing or a cylindrical bearing may be provided in an area where the knuckle 10 and the main wheel drive shaft 22 contact each other. A plurality of bearings may be located in an area where the main wheel drive shaft 22 and the sub-wheel drive shaft 210 contact each other.

Accordingly, the knuckle 10, the main wheel drive shaft 22, and the sub-wheel drive shaft 210 may be configured to be rotatable independently of each other.

In one embodiment of the present disclosure, when the first motor 10 and the second motor 200 rotate at the same angular speed, only the wheel body unit 20 is rotated. In addition, when the first motor 30 rotates and the second motor 200 stops, the wheel body unit 20 and the plurality of sub-wheels 110 are simultaneously rotated. Furthermore, when the first motor 30 stops and the second motor 200 rotates, only the sub-wheel units 100 including the plurality of sub-wheels 110 are rotated.

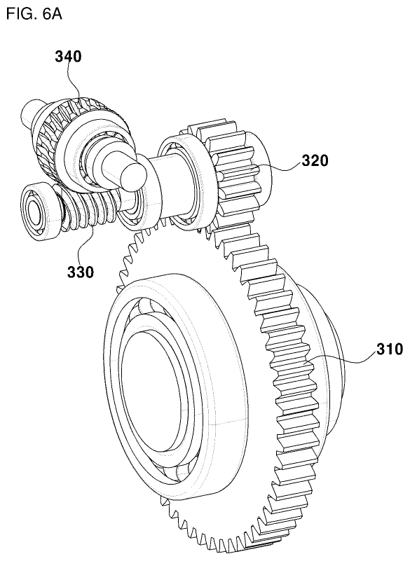

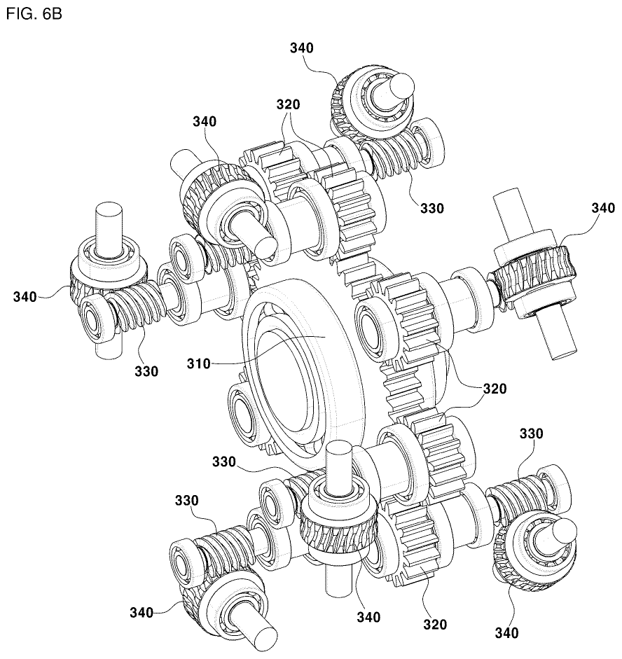

FIGS. 6A and 6B are views showing the configuration of the transmission units 300 coupled to the sub-wheel drive shaft 210 according to one embodiment of the present disclosure.

In one embodiment of the present disclosure, the transmission unit 300 includes the first gear 310 located in the inner space of the wheel body unit 20, the second gear engaged with the first gear 310, and the third gear 330 and the fourth gear 340 located between the second gear 320 and the plurality of sub-wheels 110. Further, the fourth gear 340 is engaged with the third gear 330 and is located on the side surface of each of the plurality of sub-wheels 110.

The first gear 30 transmits the driving force of the sub-wheel drive shaft 210 to the second gear 320 and the second gear 320 transmits the driving force to the fourth gear 340 through the third gear 330 provided coaxially with the second gear 320. The second gear 320 and the third gear 330 may be formed integrally and may be coupled to each other using a conventional coupling method so that the second gear 320 and the third gear 330 include gear teeth to perform gear engagement and are located coaxially.

In one embodiment of the present disclosure, the third gear 330 is provided as a worm gear, the fourth gear 340 is provided as a worm wheel gear, and thereby, the fourth gear 340 is coupled to the side surface of one sub-wheel 110. More specifically, both side surfaces of the fourth gear 340 may be coupled to adjacent sub-wheels 110. Further, the fourth gear 340 is arranged orthogonally to the third gear 330 and may perform a self-locking function by adjusting a helix angle.

The third gears 330 extend along the inner and outer side surfaces of the wheel body unit 20 in the second direction. Further, the third gears 330 may extend alternately along both side surfaces of the wheel body unit 20 in order to be coupled to the sub-wheel units 110 arranged in two rows. The number of the third gears 330 corresponds to the number of the sub-wheels 110.

In one embodiment of the present disclosure, the third gears 330 are coupled to the sub-wheel unit 100 located in one row and extend along one side surface of the wheel body unit 20 coaxially with the second gears 320. The third gears 330 are coupled to the sub-wheel unit 100 located in the adjacent other row and extend along the other side surface of the wheel body unit 20. Further, in each of the first sub-wheels unit 100a and the second sub-wheel unit 100b, each of which includes four sub-wheels 110 to form one row, four third gears 330 extend in a direction corresponding to one row. Both ends of the sub-wheels 110 located adjacent to each other in one row are coupled to the fourth gears 340. In other words, two different fourth gears 340 are coupled to both ends of one sub-wheel 110, respectively, so that driving force may be applied to the sub-wheel 110.

As shown in FIG. 6B, the transmission units 300 according to the present disclosure form four connection structures for each of the first sub-wheel unit 100a and the second sub-wheel unit 100b. Four fourth gears 340 are located at the sides of four sub-wheels 110 located in each row.

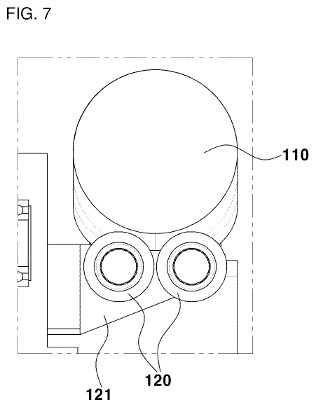

FIG. 7 is a side view showing the configuration of the support rollers 120 according to one embodiment of the present disclosure.

The sub-wheel units 100 include the first sub-wheel unit 100a located adjacent to the outer circumferential surface of the wheel body 21 and the second sub-wheel unit 100b located adjacent to the outer circumferential surface of the main wheel drive shaft 22.

Further, the support rollers 120 are provided and support the rear surfaces of the plurality of the sub-wheels 110 forming the first sub-wheel unit 100a. More specifically, the support rollers 120 may be provided as two rollers, which contact the outer circumferential surface of the sub-wheel 110. The two rollers 120 are coupled to a bracket 121 extending from the wheel body 21 and support the rear surface of the sub-wheel 110 forming the first sub-wheel unit 100a.

In addition, the support rollers 120, which support the rear surfaces of the plurality of the sub-wheels 110 forming the second sub-wheel unit 100b, may be located through brackets 121 coupled to the outer surface of the main wheel drive shaft 22.

The support rollers 120 may be provided at a position corresponding to the center of each sub-wheel 110. More specifically, the support rollers 120 may be located on the wheel body 21 and/or the main wheel drive shaft 22 so that the number of the support rollers 120 corresponds to the number of the sub-wheels 110.

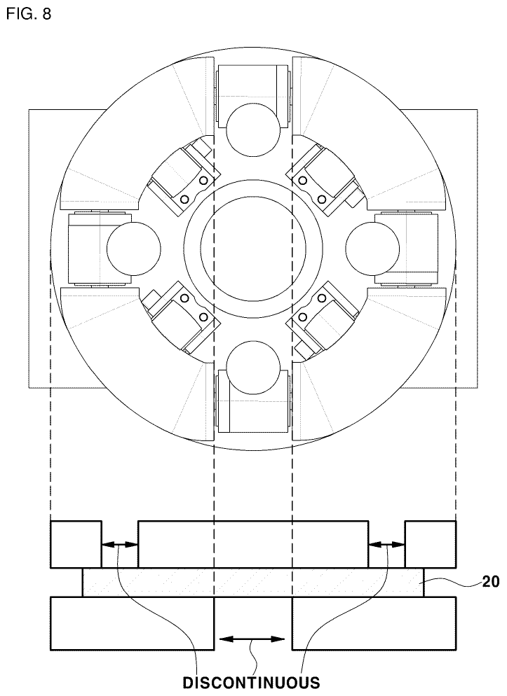

FIG. 8 is a side view of the omnidirectional rotation drive apparatus, to which the sub-wheels 110 are coupled, according to one embodiment of the present disclosure.

As shown in FIG. 8, the omnidirectional rotation drive apparatus includes the sub-wheel units 100, each of which includes four sub-wheels 110 arranged in one row, and both ends of each sub-wheel 110 are coupled to the fourth gears 320 of the transmission units 300. A discontinuous area is provided in an area between adjacent sub-wheels 110 located in the same row, to which the fourth gear 320 is coupled, in the rotating direction of the wheel body unit 20.

However, the sub-wheel unit 100 in the other row located adjacent to the sub-wheel unit 100 forming the one row includes four sub-wheels 110, which alternate with the sub-wheels 110 arranged in the one row in the width direction of the wheel body unit 20. In other words, the sub-wheels 110 located in the adjacent other row are located at an angle of about 45 degrees with the sub-wheels 110 located in the one row in the radial direction of the wheel body unit 20 with respect to the wheel body unit 20. The discontinuous area between adjacent sub-wheels 110, to which the fourth gear 320 is coupled, becomes a continuous area due to the sub-wheels 110 located in the other row, as viewed from the side.

Accordingly, the sub-wheel units 100 arranged in two or more rows along the outer circumferential surface of the wheel body unit 20 are configured to have a continuous circular shape surrounding the outside of the wheel body unit 20. Therefore, due to the structure of the plurality of sub-wheels 110 alternately located in the inner and outer areas of the wheel body unit 20, the sub-wheel units 100 may provide a continuous circular shape on the side of the wheel body unit 20.

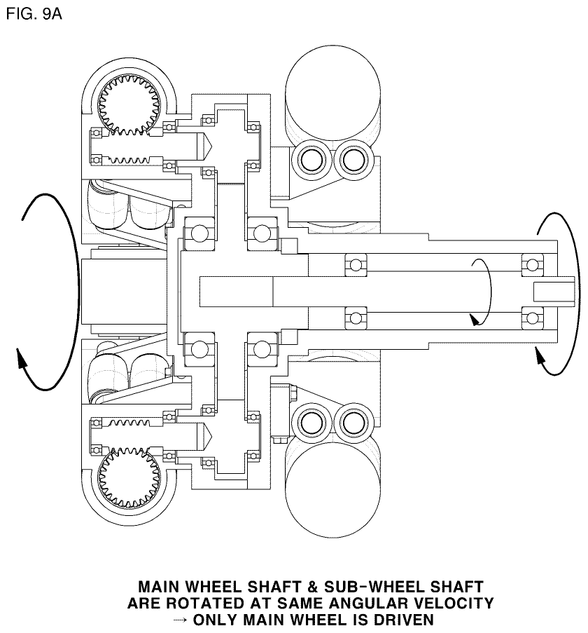

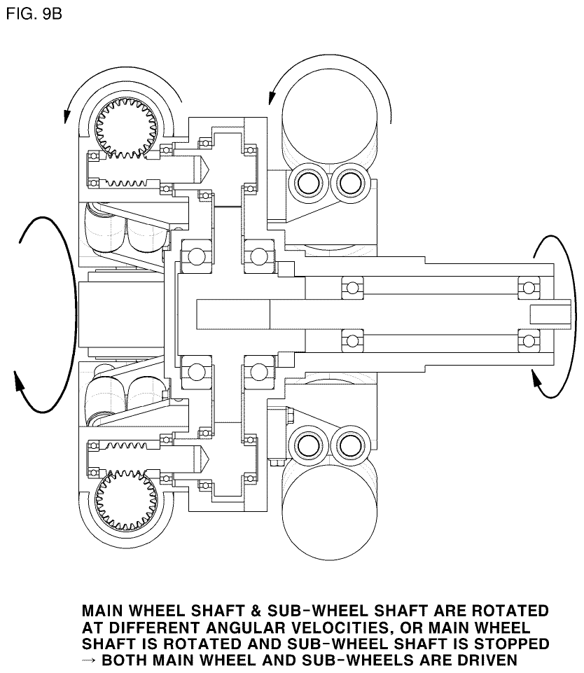

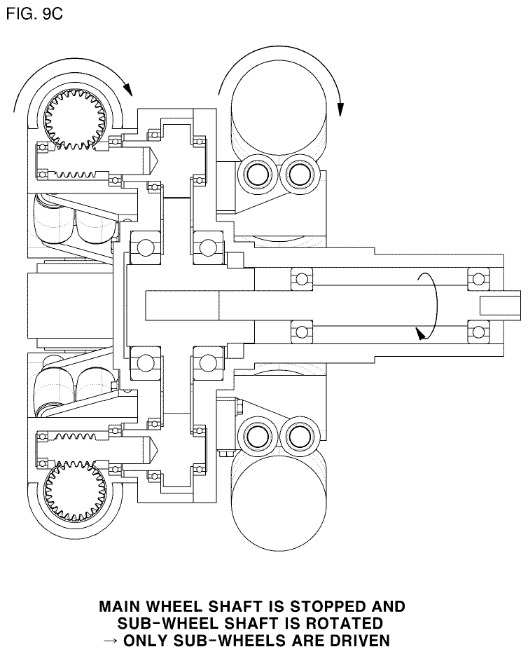

FIGS. 9A-9C are views showing a driving relationship between a main wheel (i.e., the wheel body unit 20) and sub-wheels (i.e., the sub-wheel units 100) due to an angular velocity difference between the first motor and the second motor.

As shown in FIG. 9A, if or when the first motor and the second motor rotate to have the same angular speed, the rotation speed of the main wheel drive shaft and the rotation speed of the sub-wheel drive shaft are the same. Accordingly, only the wheel body unit 20 is rotated depending on the angular speed of the first motor.

In addition, as shown in FIG. 9B, if or when the first motor and the second motor have different angular velocities, the wheel body unit 20 is rotated depending on the angular velocity of the first motor, and the sub-wheel units 100 are controlled to be rotated at a speed corresponding to an angular velocity difference between the first motor and the second motor.

In other words, if the angular velocities of the first motor and the second motor are different, a driving path having a predetermined angle with respect to the rotation direction of the wheel body unit 20 may be set.

Lastly, as shown in FIG. 9C, if or when the first motor is not driven and the second motor has a designated angular velocity, the sub-wheel units 100 are rotated at a speed corresponding to the angular velocity of the second motor. Further, the vehicle may travel to the right or left in the figure depending on the rotation direction of the second motor.

In addition, the sub-wheel units 100 driven, as shown in FIGS. 9B and 9C, may be configured to be rotated along both sides of the wheel body unit 20 depending on the number of gears of the transmission units 300 and the driving direction of the second motor.

As should be apparent from the above description, the present disclosure may obtain the following effects through the configuration, combination, and usage relations disclosed in the above-described embodiments.

The present disclosure provides an omnidirectional rotation drive apparatus that includes transmission units coupled to the inside of a wheel body and that applies driving force to sub-wheels arranged in two rows, which are coupled to a plurality of gear areas and located perpendicularly on the outer circumferential surface of the wheel body.

In addition, the present disclosure has the effect of being able to freely set the driving direction of a vehicle to any desired direction through the omnidirectional rotation drive apparatus having an omni-wheel structure capable of driving in the first direction and/or the second direction.

Further, the present disclosure provides sub-wheel driving conditions using the transmission units, thereby having the effect of designing the driving apparatus to have a compact size.

The above detailed description is illustrative of the present disclosure. In addition, the above description is intended to illustrate the example embodiments of the present disclosure, and thus the present disclosure may be used in various other combinations, modifications, and environments. In other words, it should be apparent to those of ordinary skill in the art that various substitutions, changes, and modifications may be made that are not exemplified herein but are still within the spirit and scope of the present disclosure. The described embodiments illustrate modes for implementing the technical ideas of the present disclosure. Various changes required for specific application fields and uses of the present disclosure are also possible. Accordingly, the above detailed description of the disclosure is not intended to limit the present disclosure to the disclosed embodiments. Further, the appended claims should be construed to include other embodiments as well.

What is claimed is:

1. An omnidirectional rotation drive apparatus comprising:
a knuckle connected to a vehicle body;
a wheel body unit rotatably fixed to the knuckle;
a sub-wheel drive shaft rotatably supported on the wheel body unit;
sub-wheel units rotatably supported on the wheel body unit; and
transmission units connected to the sub-wheel drive shaft to transmit rotational force from the sub-wheel drive shaft to the sub-wheel units,
wherein the sub-wheel units are rotated depending on an angular velocity difference between the wheel body unit and the sub-wheel drive shaft.

2. The omnidirectional rotation drive apparatus of claim 1, wherein the wheel body unit comprises:
a main wheel drive shaft rotatably supported on the knuckle; and
a wheel body coupled to the main wheel drive shaft,
wherein the wheel body unit has a space formed therein so that a portion of each of the transmission units is located in the space.

3. The omnidirectional rotation drive apparatus of claim 2, wherein at least a portion of each of the transmission units is located between the main wheel drive shaft and the wheel body.

4. The omnidirectional rotation drive apparatus of claim 1, wherein:
each of the sub-wheel units comprises a plurality of sub-wheels; and
central axes of rotation of the plurality of sub-wheels are perpendicular to a central axis of rotation of the wheel body.

5. The omnidirectional rotation drive apparatus of claim 1, wherein the sub-wheel units are arranged to form two rows with the wheel body unit interposed therebetween in a direction of an axis of rotation of the wheel body.

6. The omnidirectional rotation drive apparatus of claim 2, further comprising:
a first motor configured to rotate the main wheel drive shaft; and
a second motor configured to rotate the sub-wheel drive shaft.

7. The omnidirectional rotation drive apparatus of claim 1, wherein each of the transmission units comprises:
a first gear connected to the sub-wheel drive shaft;
a second gear engaged with the first gear;
a third gear arranged coaxially with the second gear;
a fourth gear engaged with the third gear and connected to a corresponding one of the sub-wheel units; and
a transmission unit housing.

8. The omnidirectional rotation drive apparatus of claim 7, wherein the third gear and the fourth gear are arranged so that an axis of rotation of the third gear and an axis of rotation of the fourth gear are perpendicular to each other.

9. The omnidirectional rotation drive apparatus of claim 7, wherein:
the transmission unit housing is fixed to the wheel body; and
the second gear is rotatably supported on the wheel body unit.

10. The omnidirectional rotation drive apparatus of claim 4, further comprising:
support rollers fixed to the wheel body to rotatably support the plurality of sub-wheels.

11. The omnidirectional rotation drive apparatus of claim 1, wherein, if the wheel body unit and the sub-wheel drive shaft are rotated at the same angular velocity, only the wheel body is rotated.

12. The omnidirectional rotation drive apparatus of claim 1, wherein, if the wheel body unit and the sub-wheel drive shaft are rotated at different angular velocities or if the wheel body unit is rotated and the sub-wheel drive shaft is stopped, the wheel body and the sub-wheel units are rotated simultaneously.

13. The omnidirectional rotation drive apparatus of claim 1, wherein, if the wheel body unit is stopped and the sub-wheel drive shaft is rotated, only the sub-wheel units are rotated.
